(19) United States
(12) Patent Application Publication
(10) Pub. No.: US 2008/0071614 A1
(43) Pub. Date: Mar. 20, 2008

(54) Shopping System and Method

(75) Inventor: Robert Mebruer, Singapore (SG)

Correspondence Address: SUGHRUE MION, PLLC, 2100 PENNSYLVANIA AVENUE, N.W., SUITE 800, WASHINGTON, DC, 20037, US

(73) Assignee: U-MARKETING INTELLECTUAL PROPERTIES PTE. LTD., Singapore (SG)

(21) Appl. No.: 11/628,985

(22) PCT Filed: Jun. 8, 2005
(86) PCT No.: PCT/SG05/00185

§ 371 Date: Feb. 27, 2007

(30) Foreign Application Priority Data
Jun. 8, 2004 (AU) 2004903120
Jul. 22, 2004 (AU) 2001904076

(51) Int. Cl. G06F 17/30; G06Q 30/00

(52) U.S. Cl. 705/14

(57) ABSTRACT

A shopping system and method is disclosed for providing an inducement to a shopper to purchase products. The inducement may be by way of a shopping list or a coupon providing benefits when products are purchased. A card reader (105, 515) is provided for reading a customer's card to identify the customer, and processors (P1, P2) are provided for containing databases which include customer information so that targeted offers can be made specific to a particular customer by way of a printed shopping list or coupon. A printer (112) is provided for printing the list and a printer (516) is provided for printing the coupons. Information relating to redeemed coupons is also obtained so that organisations making offers by way of the coupons can be built for the promotional offers included on the coupons.

### FIELD OF THE INVENTION

The present invention relates to a shopping system and method which provides a shopping inducement to a shopper. In particular, but not exclusively, the invention relates to providing a shopping list or coupon which contains promotional offers relating to various products so as to directly advertise those products to the shopper to induce the shopper to purchase those products.

### BACKGROUND OF THE INVENTION

Typically in a retail outlet such as a supermarket or hypermarket it is not uncommon for between 15,000 and 50,000 different items to be on offer for sale. Promoting such a wide range of products is difficult and very expensive. Traditional methods of advertising include in-store advertising, provision of coupons at check-outs, and general media broadcasting. These forms of advertising can be inefficient because only a certain class of people may be interested in a particular product.

In-store advertising tends to become part of the store “wall paper” and therefore may not be readily noticed by consumers.

Traditional coupon-type advertising generally has very high wastage and is also costly. Furthermore, since this advertising is provided at the check-out it does not provide an immediate inducement to purchase and may well be forgotten next time a consumer goes shopping.

Coupons normally contain an offer which can be redeemed at a particular place. Most commonly, the offer is a price-off offer, say $1 off the purchase price of a particular product. However, the offer may be to obtain additional products when a particular product is purchased, or the like.

Typically, coupons are redeemed by a user physically handing over a printed coupon at a particular location, such as at a checkout where consumers pay for products purchased in supermarkets or the other retail or like outlets.

One problem associated with the provision of coupons is the targeting of consumers who should receive the coupons. In some instances, coupons may be provided to consumers who have no interest in the offer provided on the coupon, and therefore the provision of the coupon is wasted and the advertising benefit which was hoped to be obtained by providing the coupon is not obtained.

Another problem is the handling and management of the coupons because when a physical coupon is handed over at a checkout in a store, it needs to be collected so the outlet can redeem the value of the coupon from the advertiser concerned. Usually this is done by forwarding the coupons to a dedicated coupon clearance house that collects and manages the administrative process and deals with charging and billing participating brands.

It is most usual for coupons to be printed on paper. However, for the purpose of this specification, it should be understood that the word “coupon” refers to any communication vehicle which provides consumers with an offer to act in a certain way. Thus, the coupons may be in the form of printed coupons, or could be virtual coupons such as displays on video screens such as computer screens, mobile telephones or the like.

Traditional advertising by broadcast media is also expensive and also suffers from the disadvantage of time lag between seeing the promotional offer and an actual shopping activity.

Modern media fragmentation results in lower coverage compared to when mainstream media where fewer in number and the reach factors where higher. Today a multimedia strategy is necessary to cover a broad spectrum of shoppers. Furthermore, the challenge for attention, as modern society becomes an over-communicating environment, results in stimulus overload and tune out or selective retention. Traditional media is challenged by other modern distractions such as the internet, mobile phones, texting and therefore the effectiveness of traditional media advertising is likely to be less.

People today are also time-poor. In a shopping environment, it is not sufficient to provide a wide range of goods or products. In a typical modern supermarket or hypermarket an average shopper may walk past as many as 300 items every ten seconds. The issue no longer is about providing more choices but how retailers in such as situations help the shopper to decide what products to buy and win their loyalty.

### SUMMARY OF THE INVENTION

The present invention may set to reside in a shopping system comprising:
(a) an input device for receiving input to identify a shopper;
(b) a shopper database for storing data relating to shopping characteristics of shoppers;
(c) a processor for generating a shopping inducement for the shopper containing items of perceived interest to the shopper based on the data relating to the shopper stored in the shopper database, the data comprising past purchase history, attitudinal segmentation and geo-demographics; and
(d) an output device for outputting the shopping inducement to the shopper.

The invention therefore enables a specific shopping inducement to be generated for a particular shopper which contains products which are perceived as being of interest to the shopper. Thus, specific products may be advertised by way of mentioned on the shopping inducement or by a particular promotional offer including possible discounts, or extra benefits associated with purchasing a particular product.

The present invention also enables consumers to be targeted, not only based on past purchase history but on attitudinal segmentation that a consumer is likely to have to new products not previously purchased, and on their geo-demographics. Thus, it is possible to select future consumers and target them on the basis of their perceptions, for example, how they perceive different attributes and benefits of marketing brands, and these represent marketing opportunities.

Furthermore, the shopping inducement can be generated at the time a shopper commences shopping and therefore is more relevant to the shopper, who is about to undertake a shopping exercise, than broad base media advertising which may occur a considerable time prior to a shopping activity.

In one embodiment the shopper database is included in the processor. However, in other embodiments the database may be separate from the processor or including a completely separate processor.

In the preferred embodiment of the invention the processor comprises a first processor located at a central station and a second processor located at a retail outlet. Thus, each retail outlet which operates the shopping system is provided with its own processor and the system further includes a communication link for linking the first processor to each second processor.

Preferably the shopper database comprises a customer database included in the first processor and a store database included in the second processor.

Preferably the first processor also includes a retailer EPOS server.

Preferably the first processor includes a retailer central server.

In one embodiment the first processor is programmed to generate and manage promotional offers applicable to all shoppers and targeted promotions which are targeted at specific shoppers, and is also programmed to select specific shoppers for the targeted promotion.

Preferably the input device comprises a card reader for reading a card belonging to a shopper to thereby identify the shopper.

Preferably the card reader is coupled to the store database for supplying data relating to the shopper to the store database.

In one embodiment the output device is a printer coupled to the second processor for providing the shopping inducement in printed form.

Preferably the store database is coupled to the retail EPOS server for providing data to the retail EPOS server identifying the shopper and also the items on the shopping inducement produced for the shopper.

Preferably a secondary input device is coupled to the retail EPOS server for receiving an input to identify the shopper so that when items purchased by the shopper pass through check-out those items which are on the shopping list are supplied to the shopper in accordance with the promotional offer as provided on the shopping inducement.

Preferably the retail central server is for receiving information relating to the shopping characteristics of shoppers, the retailer central server being coupled to the customer database for storing the shopping characteristics of the respective shoppers in the shopper database.

The shopping inducement may be in the form of a printed shopping list of articles or may be presented as a coupon.

The present invention may set to reside in a shopping method comprising:
(a) receiving an input to identify a shopper;
(b) providing a shopper database which stores data relating to shopping characteristics of shoppers;
(c) generating a shopping inducement for the shopper containing items of perceived interest to the shopper based on the data relating to the shopper stored in the shopper database, the data comprising past purchase history, attitudinal segmentation and geo-demographics; and
(d) outputting the shopping inducement to the shopper.

In one embodiment the method further comprises generating promotional offers applicable to all shoppers and targeted promotions which are targeted at specific shoppers, and selecting specific shoppers from the database for the targeted promotion.

Preferably the method further includes supplying the data identifying the customer and the shopping inducement to a check-out station so that when the shopper passes through the check-out station items purchased by the shopper and which related to the shopping list are provided in accordance with the shopping list.

In one embodiment the shopping inducement comprises a printed shopping list.

In another embodiment the shopping inducement comprises a coupon.

The invention may be said to reside in a system for providing a coupon to a consumer, comprising:

an input device for receiving an input to identify a consumer;

a database for storing data relating to the characteristics of consumers, the data comprising past purchase history, attitudinal segmentation and geo-demographics;

a processor for determining consumers who are to receive the coupon; and

an output device for providing the coupon to a consumer.

Thus, with the system according to the invention, a decision as to whether a consumer is to receive a coupon can be based on characteristics of consumers and the nature of offers on the coupon so that they are relevant to people who will receive the coupon. This therefore results in the more likely targeting of offers to people who are likely to accept the offers and obtain benefit from the offers and thereby provide the party providing the offer with advertising awareness.

Preferably the system further comprises a second processor for providing electronically details of the offers on the coupon provided to the consumer so that when the consumer presents at a checkout and pays for goods, any goods which are purchased and relevant to offers on the coupon are provided to the consumer in accordance with the offer on the coupon.

Thus, the consumer may obtain a discount in price for relevant articles, and extra benefit or product provided at the checkout or the like.

In one embodiment of the invention, the input device comprises a card reader for reading a card belonging to the consumer to identify the consumer. The card may include data identifying the consumer by way of a pin number or other identifying data.

The card may be a smart card or a simple card having a magnetic strip.

In one embodiment of the invention, the database is retained in a central location and the processor comprises a first processor at the central location, the first processor receiving data from the database and processing the data for creating a targeted coupon list.

Preferably the second processor is located at a retail outlet for receiving the coupon list, the second processor being coupled to the output device for causing the output device to provide the coupon to the consumer.

In one embodiment, the output device may comprise a printer which prints the coupon in response to a consumer inputting information into the input device to identify the consumer.

In another embodiment, the output device may comprise an EPOS checkout location in a store for providing the coupon for redemption next time the consumer visits the store.

In one embodiment of the invention, a plurality of said input devices are provided throughout a retail outlet and a plurality of output devices are also provided so that, at different locations in a retail store, a consumer can obtain a coupon relevant to all products targeted for that particular consumer, or only products which are in the vicinity of the input device and output device to provide a greater degree of interaction between those particular products and the issuance of the coupon.

In other embodiments, the output device may comprise other devices for providing the consumer with the coupon such as by way of text message or telephone call to a mobile telephone.

Preferably the database also stores information relating to consumers which identifies a home store which the consumer frequents, and the first processor forwards the coupon list to the second processor located at the home store.

Most preferably the first processor includes the said database, a server for determining products which are to be included on the coupons, and the targeted consumers for receiving coupons, and an application server for generating the coupon list for transmission to the second processor.

Preferably a said second processor is located at each stores operating the system, the second processor including a database for receiving the coupon list transmitted from the first processor, and for controlling the output device to provide the coupon to the consumer.

The invention may also be said to reside in a method of providing a coupon to consumers, comprising:

identifying a consumer;

producing a coupon in response to an identified consumer containing offers relevant to the consumer based on data contained in a database, the data comprising past purchase history, attitudinal segmentation and geo-demographics; and

outputting the coupon to the consumer.

In one embodiment of the invention, the identification of a consumer is by a card reader for reading a card belonging to the consumer to identify the consumer. The card may include data identifying the consumer by way of a pin number or other identifying data.

In one embodiment of the invention, a database of consumer characteristics is retained in a central location and the method further comprises processing data from the database to create a coupon list to be provided for particular consumers based on the stored characteristics in the database, and products which are desired to be advertised by way of the provision of the coupon.

Preferably the method also comprises receiving the coupon list at a retail outlet and processing the coupon list and information identifying consumers at the retail outlet to provide an indication of the consumers to receive the coupon.

In another embodiment, the indication is provided at an EPOS checkout location in a store for providing the indication of the consumer to receive the sample.

In other embodiments, the indication may comprise other ways of providing a consumer with a coupon such as by way of text message or telephone call to a mobile telephone.

Preferably the method also comprises identifying a home store at which the consumer purchase products and forwarding the sample list to the home store.

Most preferably the processing at the central location is performed by a first processor which includes the said database, a server for determining products which are to be advertised on the coupon, and the targeted consumers for receiving those free samples, and an application server for generating the coupon list for transmission to the second processor.

Preferably the processing at the retail outlet is performed by a second processor located at a retail store operating the system, the second processor including a database for receiving the coupon list transmitted from the first processor, and for controlling the output device to provide the coupon to the consumer.

A second aspect of the invention is concerned with management of the provision of coupons to reduce the amount of work related to collection of coupons, and charging and billing participants in relation to offers contained on the coupons and provided to consumers.

This aspect of the invention may be said to reside in a system for providing coupons to consumers, comprising:

a processor for:

producing a coupon and providing the coupon to a consumer;

providing electronically details of offers on the coupon to a redemption station so that when a consumer accepts at the redemption station offers on the coupon, the consumer receives the offers on the coupon; and

providing electronically details of accepted offers on the coupon so participating parties making offers on the coupon can be billed in relation to those which are taken up by consumers.

Thus, according to this aspect of the invention, it is not necessary for coupons to be collected and for coupons to be physically delivered to a clearing house for reconciliation and for billing to advertisers and the like who make offers on the coupon. Thus, costly physical coupon handling is at least reduced and coupon clearing infrastructure can also be reduced if not completely eliminated.

In one embodiment, the processor comprises a store server for producing the coupon and providing the coupon to a consumer, and an EPOS checkout terminal for receiving details of offers on the coupon relating to a particular consumer from the server, the EPOS checkout terminal forming the redemption station and processing offers on a coupon relating to a particular consumer in accordance with products purchased by the consumer at the checkout terminal, and a further processor for receiving electronically, details of offers provided to consumers for billing the participating parties making offers on the coupon.

In one embodiment of the invention, the system further comprises an input device for identifying a consumer.

In one embodiment, the system further includes an output device for providing the coupon to the consumer.

Preferably the processor comprises a first processor and the first processor has a database for storing characteristics of consumers so that a coupon can be produced for particular consumer which contains offers relevant to the consumer based on information contained within the database relating to that consumer.

Thus, the consumer may obtain a discount in price for relevant articles, and extra benefit or product provided at the checkout or the like.

In one embodiment of the invention, the input device comprises a card reader for reading a card belonging to the consumer to identify the consumer. The card may include data identifying the consumer by way of a pin number or other identifying data.

The card may be a smart card or a simple card having a magnetic strip.

In one embodiment of the invention, the first processor is located at a central location, the first processor receiving data from the database and processing the data for creating a targeted coupon list.

Preferably the processor further comprises a second processor located at a retail outlet for receiving the coupon list, the second processor being coupled to the output device for causing the output device to provide the coupon to the consumer.

In one embodiment, the output device may comprise a printer which prints the coupon in response to a consumer inputting information into the input device to identify the consumer.

In another embodiment, the output device may comprise an EPOS checkout location in a store for providing the coupon for redemption next time the consumer visits the store.

In other embodiments, the output device may comprise other devices for providing the consumer with the coupon such as by way of text message or telephone call to a mobile telephone.

Preferably the database also stores information relating to consumers which identifies a home store which the consumer frequents and preferably, the first processor forwards the coupon list to the second processor located at that store.

The second aspect of the invention may also be said to reside in a method of providing a coupon to a consumer, comprising:

producing and providing the coupon to a consumer;

providing electronically details of offers on the coupon to a redemption station so that when a consumer accepts at the redemption station offers on the coupon, the consumer receives the offers on the coupon; and

providing electronically details of accepted offers on the coupon so participating parties making offers on the coupon can be billed in relation to those which are taken up by consumers.

Preferably the coupon is supplied to a consumer from a server and the server also supplies electronically, details of the coupon to an EPOS checkout terminal which comprises the redemption station, the EPOS checkout terminal processing sales relating to a consumer in accordance with details on a coupon provided to the consumer, and providing electronically, details of accepted offers to a further processor so the further processor can bill the participating parties in relation to the offers which are taken up by consumers.

Preferably the coupon is produced and provided from data retained in a database which stores characteristics of consumers so that the coupon can be produced for a particular consumer, which contains offers relevant to the consumer based on information contained within the database relating to that consumer.

Preferably the method further comprises identifying a consumer so that the coupon relevant to the particular consumer can be produced.

Preferably the method comprises receiving data from the database and processing the data for creating a targeted coupon list, and forwarding the targeted coupon list to a retail store for printing in response to the identification of a consumer at the retail store.

Preferably the method also includes identifying a home store which the consumer frequents so that the targeted list can be forwarded to the home store relating to particular consumers.

The invention also provides a shopping system comprising:

a plurality of shopping outlets;

an input device for receiving an input to identify a shopper;

a store database located at each shopping outlet;

an output device for outputting a shopping inducement to the shopper;

a central processing section remote from the retail outlet and connected to respective store databases by a communication link, the central database containing customer data relating to shopping characteristics of shoppers;

a processor at the central processing section for processing information in the database to produce shopping inducements and for forwarding the shopping inducements to respective store databases at respective outlets via the communication link; and

wherein when a shopper identifies himself or herself by an input into the input device, any inducements relating to that shopper are produced at the output device for collection by the shopper to induce the shopper to purchase items contained on the shopping inducement.

Preferably a store processor is located at each of the outlets for managing the store database and also for providing data back to the central section relating to purchases made by shoppers for inclusion in the customer database.

Preferably the processor at the central section includes a server having a retailer's inventory system and a retailer's database.

Preferably the shopping outlets are physical shops, a said input device and a said output device are located at each shop.

The invention further provides a shopping method comprising:

receiving data from an input device to identify a shopper;

providing a store database located at each shopping outlet of a plurality of outlets;

producing a shopping inducement to the shopper;

providing a central processing section remote from the retail outlet and connected to respective store databases by a communication link, the central database containing customer data relating to shopping characteristics of shoppers;

processing at the central processing section information in the database to produce shopping inducements and forwarding the shopping inducements to respective store databases at respective outlets via the communication link; and

wherein when a shopper identifies himself or herself by an input into the input device, any inducements relating to that shopper are produced at the output device for collection by the shopper to induce the shopper to purchase items contained on the shopping inducement.

Preferably the method further comprises providing a store processor at each of the outlets for managing the store database and also for providing data back to the central section relating to purchases made by shoppers for inclusion in the customer database.

Preferably the processor at the central section includes a server having a retailer's inventory system and a retailer's database.

Preferably the shopping outlets are physical shops, a said input device and a said output device are located at each shop.

### BRIEF DESCRIPTION OF THE DRAWINGS

Preferred embodiments of the invention which described, by way of example, with reference to the accompanying drawings in which:

FIG. 1 is a blocked diagram showing system architecture according to one embodiment of the invention;

FIG. 2 is a blocked diagram for illustrating input of shopper data into the system of FIG. 1;

FIG. 3 is a blocked diagram showing generation of promotional offers according to one embodiment of the invention;

FIG. 4 is a blocked diagram showing user interaction with the system of FIG. 1; and

FIG. 5 is a block diagram of a second embodiment of the invention.

### DETAILED DESCRIPTION OF THE PREFERRED EMBODIMENT

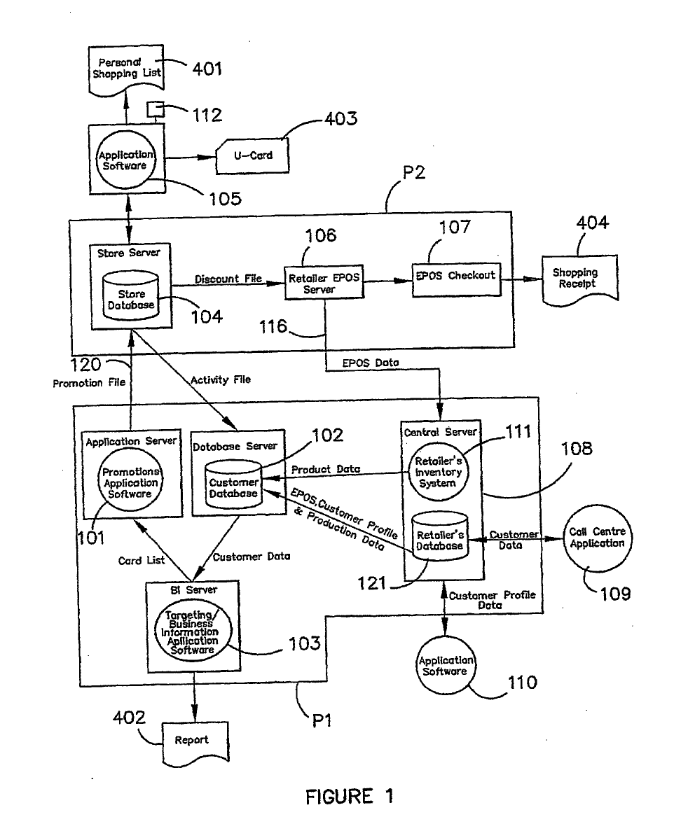

With reference to FIG. 1 a shopping system is shown from which the shopping method according to preferred embodiment will also be apparent.

The system in FIG. 1 comprises a processor P1 which is located at a central station and which communicates with store processors P2 (only one shown) located at retail stores by a communication link 111.

The processor P1 is programmed with promotions application software schematically represented at 101 in FIG. 1, and targeted applications software schematically represented at 103 in FIG. 1. The processor P1 may also be made up of a customer database 102 and a retailer central server 108.

The software 101 caters for both universal and targeted shopper promotions. Universal promotions are available to all shoppers who use the system and targeted promotions are targeted at a specific group of shoppers who use the system. For example, a targeted promotion may target females who have children aged 0 to 5.

Thus, the promotional software 101 generates various promotions which can be offered to shoppers using the system at particular retail outlets. In order to generate the various promotions, a set of promotions are input into the software 101 by the central authority operating the system, and the software 101 creates the required promotion files. The promotion files in XML format are then uploaded from the software 101 to the store database 104 via a suitable communication link, which may comprise a dedicated line, internet connection, wide area network 120, or the like. Most preferably the files are uploaded through a wide area network using the file transfer protocol. The promotional offers generated by the software 101 may be common to all stores using the system or may differ from store to store depending on the nature the store, the location of the store, the type of people who shop at the store etc.

The customer database 102 holds data relating to the identity of individual shoppers such as a pin number, account number or any other suitable identifying data, and also shopping characteristics relating to that particular shopper. These characteristics include personal data such as whether the shopper is male, female, age group, as well as other specific characteristics relating to the types of products of interest to the shopper.

The database therefore contains data relating to the past purchase behaviour of a consumer and, additionally, attitudinal segmentation, geo-demographics and any other criteria categorizing shoppers. The benefit of including attitudinal segmentation means that data relating to the general attitudes of consumers is provided. This allows the selection of future customers and the targeting of those customers based on their perceptions (for example, how they perceive different attitudes and benefits of marketing brands, and how these represent marketing opportunities). Thus, products which may not have been purchased by the consumer or completely new products may be targeted to consumers based on an analysis of what those consumers perceive and what they are likely to purchase based on their attitude. Similarly, consumers can be segmented based on different attitudes, interests, opinions and lifestyles, which provides much better targeting than simple reliance on past purchase history. Geo-demographics enables targeting based on family size, educational levels, where people live and work, and also provides better targeting of people over simple past purchase history. Thus, the present embodiments allow better flexibility by using purchase behaviour, attitude, lifestyle, psychographics, geo-demographics or a combination of these various parameters, and better targeting because as more selection criteria is developed, the targeting is tighter and sharper. Furthermore, the actual size of the target selection is known and qualification is predetermined, allowing clear ideas of cost of promotional programs, opportunities and competitive dynamics. Hence, the targeting can be scaled up or down according to the flexibility of extending or limiting the targeting criteria. In the preferred embodiments of the invention, the focus on datamining, analytical and business intelligent tools and key strategy development is very much more extensive and the nature of the data retained so that target groups can be predetermined and forwarded to stores where those shoppers shop to identify, match and offer the specific shopping lists or shopping coupons to the targeted group of consumers. Furtherstill, by combining both a shopping list and coupon system, combinations of conditions can be provided. For example, if coupons are issued at, for example, kiosks located along shopping isles and shelves, the coupons can be made conditional on qualification of activating a shopping list. For example, the shopper may be required, as a condition to get better discounts or more benefits, to activate both a shopping list and the coupons in combination so that a promotional message is maximised. For example, the same consumers may be offered a shopping list with a particular benefit should a product be purchased, and a coupon which provides a further benefit, for example, one dollar off the price of the product. The present targeting also enables cash back systems to be offered in which the inducement is in the form of a cash back voucher where actual cash is returned to the shopper on the shopper's next purchase of any particular item. These vouchers can be offered as part of a shopping list or a coupon and can be predetermined so that shoppers accumulate a particular value which is presented back in terms of vouchers with a shopping list at the entrance to a store or at kiosks within a store.

The data relating to a particular shopper is supplied to the customer database 102 from the retail central server 108 which receives the data when a shopper joins the program. The central server 108 manages a retailer's database 121 in which customer data is initially collected from the input 110 and from information supplied by the call centre 109. The central server 108 also manages a retailer's inventory system 111 which provides product data to the customer database 102.

Retailers are able to provide protection and security to their databases 104. Customer database 102 receives information from the retailer's inventory system 111 and the store database 104 and reorganises that information in a data structure that is usable for analytical needs and targeting needs to operate the system. The data from the retailer excludes individual names and addresses of customers to protect privacy. The retailer's inventory system 111 contains product descriptions, EAN barcode of the store, and long term sales records over several years. The customer database 102 matches and merges product data from the retailer's inventory system 111 with customer identities and recent purchases. Profile data can be updated and loaded periodically.

The software 101 can support many different types of promotions including simple discount offers such as buy product X and save Y. Conditional discount offers such as buy product X and save Y with a limit of Z per customer. Bonus pack offers for example buy product X and get a second product X for free. Banded pack offers such as buy product X and get product Y for free. Sampling offers such as collect your free sample of product X from the cashier. Spend offers for example spend X today and get Y. Sweepstake offers such as buy product X five times this month and receive one free movie ticket.

The software 101 generally produces promotional offers which are universal and available to all shoppers and targeted promotions which are targeted at specific shoppers.

The software 103 selects the particular shoppers for a targeted promotion. Once, the particular targeted promotion is established, such as females who have children age 0 to 5 the software 103 then extracts from a customer database 102 all the shoppers in the database 102 who meet that particular targeted promotion. The software 103 may then generate a list of those shoppers and supplies the list to the software 101. That particular list of shoppers and the promotional offers are supplied to the store databases 104 in each of the respective retailed stores operating the system

If the retail store is a physical store which is visited by a shopper to purchase articles, a input device 105 is provided at the retail store.

In one embodiment the input device may comprise a card reader 105 which forms part of the wide area network and shoppers who use the system are provided with a card 403 which contains data identifying the shopper so that when the card is read by the card reader 105 the data is supplied to the processor P2. In other embodiments instead of using a card reader, a key pad, biometric sensor or other input device for inputting a code to a pin number to identify the particular shopper may be provided.

In the case of the retail store being a virtual store which is accessed on line via the internet the processor P2 is effectively connected through a person's personal computer by the internet connection and the input may be way of a keyboard associated with the personal computer so that a user code and password can be entered to identify the particular shopper.

When the particular shopper is identified either by swiping the card, inputting the pin code or the like, the specific characteristics relating to the shopper which are stored in the customer database 102 are extracted and considered for a particular promotional offers as created and generated by the software 101 and software 103.

Thus, a shopping list applicable to the particular shopper can be created which includes various ones of the promotional offers or all of the promotional offers which are generated by the software 101 and 103 and which are applicable to the shopper characteristics stored in the database 102 which are associated with that particular shopper. The shopping list may be generated in the processor P1 or the processor P2 or in both of the processors P1 and P2. However, in the preferred embodiment, the shopping list can only be generated in the processor P2 and then sent to printer 112 for printing the shopping list for the shopper. The shopper then collects the shopping list from the printer 112 which may be conveniently located beside the input device 105 so the shopper can peruse the list which has been printed and then commence shopping at the store.

The store database 104 is coupled to a retail EPOS server 106 which manages check out of items from the retail store at a check out location 107. Thus, data from the store database 104 which comprises the shopping list which has been generated for the particular shopper together with the data identifying the particular shopper is forwarded as a file to the retail EPOS server 106 and to the check-out location 107 for comparison with items actually purchased by the shopper when the shopper presents at the check-out 107. The check-out location 107 is provided with a second input device for the input of the data relating to the shopper to identify the shopper. Thus, in the preferred embodiment a second card reader is provided at the location 107. The card reader may comprise the conventional card reader which is used to conduct debit or credit transactions for the purchase of goods. At the check-out the shopper swipes his or her card through the card reader at the check-out 107 which identifies the customer and the particular shopping list which was generated for that customer. The item purchased by the customer is compared with the items on the shopping list and any purchase which relate to promotional items on the shopping list are provided to the shopping in accordance with the promotional offer. Thus, discounts are obtained, additional products provided etc. as explained above in relation to the various offers which may be applicable to the shopper.

As previously described, the retail central server 108 communicates with a shopping characteristic data input 110 which may be located at retail stores, and a call center input 109 so that shopping characteristics of particular shoppers can be input into the server 108. The server 108 is in communication with the customer database 102 so that the shopping characteristics of the shoppers can then be supplied to the customer database 102 at the central location.

The store database 104 also returns an activity file to the database 102 which includes data relating to personal shopping lists which are created in the processor P2 and printed out for a particular shopper. Thus, information relating to offers which are actually made, as well as those which are actually taken up by shoppers is provided.

Typically shoppers can join the shopping system by completing a membership application form. The application form will enable a shopper to provide shopping characteristics such as personal details and the nature of products of interest to the shopper. A card can then be supplied to the shopper which contains data identifying the shopper. In other embodiments rather than use a card, a PIN number, account code or other identifying characteristics may be provided to identify the shopper. The data from the application form can then be supplied by way of the shopping characteristic input 110 at the retail store. The data at input 110 may be compiled into a text file and stored on disk for loading into the retail central server 108. The data is checked for integrity and then supplied from the server 108 to the customer database 102. The input 109 enables shoppers to telephone a customer service hotline and request changes to their personal data if desired.

Thus, a customer database 102 is established which contains the information to identify a particular customer which is provided on the card supplied to the customer and also the particular shopping characteristics of the customer. In another embodiment, the card used by the customer may be a smart card as previously described. The smart card includes a smart chip which has memory storage to hold the shopping characteristics such as purchases, lifestyle, demographic and other shopping behaviour data as distinct from a simple magnetic strip type card which merely holds data identifying the shopper. Thus, the smart card may be used to update consumer data on the card, for example, the updating of transaction levels on the card to track qualifying criteria of a promotion such as a purchase (dollar value) threshold level, “spend $100 this week and win a prize”. Similarly, the updating of shopping frequency in a single day can be written onto the card. This enables a shopper who visits more than once in a day to get a fresh shopping list and targeted offers. Furtherstill, the smart card can capture other data from various retailers.

As is shown in FIG. 1 the retail EPOS server 106 is also communicates with the central server 108 so that particular purchases made by the shopper can be supplied to the retail server via communicating link 116 for addition to the shopping characteristics of that particular customer. For example, if a customer routinely buy certain products this information can be added to the customer shopping characteristics.

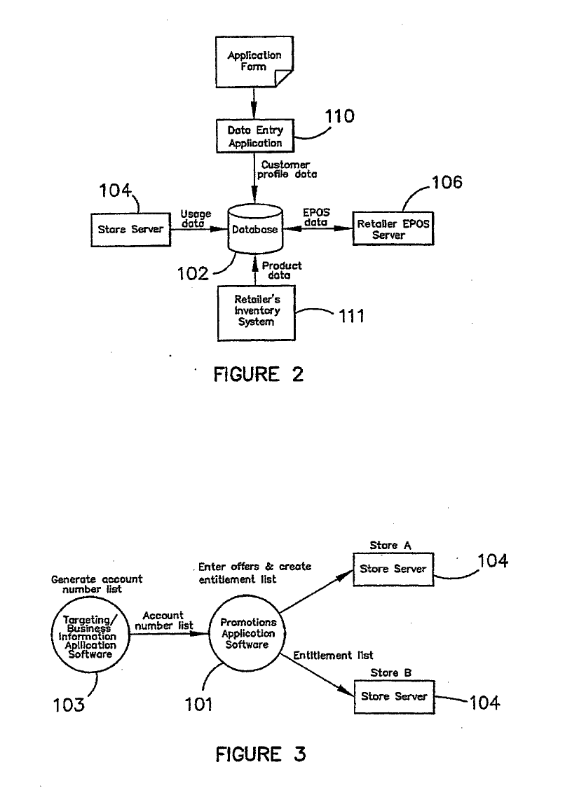

FIG. 2 is a blocked diagram showing how data is supplied to the customer database 102. As previously mentioned an application form identified as 201 in FIG. 2 supplies information which can be input via input 110 to supply particular data relating to the shopper. Data from the server 106 may also be supplied to identify particular products purchased by particular shoppers. The retailers inventory system 202 may supply information and the store server 108 also supplies information all of which is stored in the database 102.

FIG. 3 illustrates the operation of the software 101 and 103. As mentioned above this software 103 generates lists of shoppers to which a targeted promotion may relate and that list is supplied to the software 101. The software 101 generates particular promotional offers and also generates the universal promotions which may be available for all shoppers. This information is then forwarded to the stored databases 104 associated with each of the stores operating the system.

When a shopper presents at the store to commence shopping, the shopper swipes his or her card through card reader 105, or otherwise enters identifying data such a pin number into a key pad, biometric data into a sensor, or the like so that the shopper is identified. The processor P2 then extracts information from the store database 104 which contains the list of targeted shoppers and also the universal promotions. The customer shopping characteristics are identified in the customer database 102 and in processor P2 selects any items from the universal promotional offer which may be applicable to the characteristics of that particular shopper. Furthermore, if the particular shopper is on the targeted list of shoppers produced by the software 103 all the items are identified and a shopping list containing the particular universal promotional offer as well as those on the targeted list are then used to create the unique shopping list for the shopper. The shopping list is printed out at printer 112 associated with the card reader 105 so that the shopper obtains a printed shopping list at the commencement of shopping. However, in other embodiments, the shopping lists can be provided in different ways such as a web page if the shopping is being conducted at a virtual store, or via some other medium so that the shopper is provided with a list in some form at the commencement of a shopping experience. The shopper can then consider the shopping list and may choose to buy some, all or none of the particular items on the lists during the course of the purchase of products at the store.

When the shopper has completed shopping the shopper presents at the check out to pay for the goods that have been selected. As previously mentioned when the shopping list is generated for the shopper the list is supplied to the server 106 so at the check-out the particular offers made to the shopper can be identified. When the shopper is checking out the items which have been purchased the shopper again inputs the information identifying the shopper into the secondary input device at check-out 107. Once again this may be by swiping the card, input of a PIN number into a key pad, biometric data supplied to a sensor or the like. Thus, as the items are being checked-out the items are compared with the shopping list so that if a particular item is purchased which is subject to the promotional offer on the list the shopper receives the promised promotional offer.

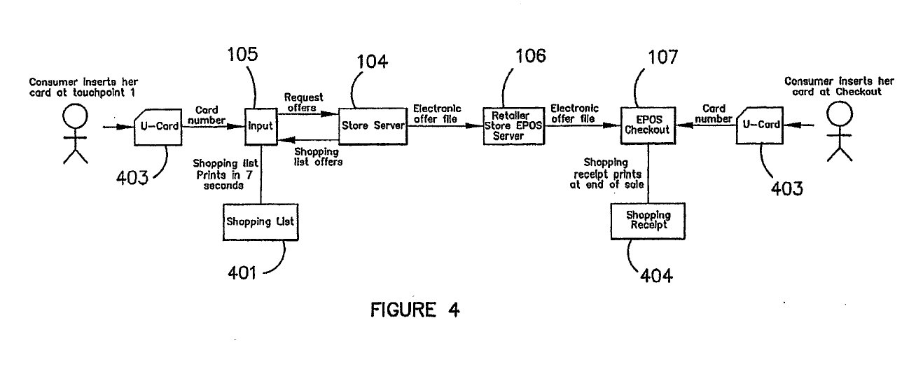

FIG. 4 is a block diagram showing the interaction of the shopper with the system. As previously mentioned the shopper supplies his or her card identified as 401 in FIG. 4 to the card reader 105 so that the shopping list identified as 402 in FIG. 4 is generated. The items on the shopping list 402 are supplied to the store server 108 and also to the store EPOS server 106. At the check-out 107 the shopper again swipes his or her card to identify the shopper and ensure that the particular promotional offers which are made to the shopper on the list are carried out at check-out 107. The check-out 107 may produce a receipt 403 relating to the items purchased by the shopper.

The preferred embodiment of the invention therefore generates a personalized shopping list for shoppers as they enter a store prior to the start of a shopping experience. The shopper swipes his or her card to generate a personal shopping list which has specific promotional office developed for that individual. The offer is linked to the point of sale check out so the shopper receives the particular promotional offers provided on the list.

Products purchased from the stores of that particular shopper may be used to establish shopping histories and geodemographic of lifestyle data which can then be analysed for further purchases and promotional offer along with particular lifestyle and preference data which is supplied by the shopper when they joining the program. Thus, the personalized shopping list provides direct promotional offers to a person expected to be attracted by the offers and to take up the offers. The offers are also made at the relevant time when shopping is about to start. The system can change promotional office frequently and set different criteria for different promotional office.

The processor P1 may also produce management reports 403 by the targeted business information application software 103 relating to the data which is stored in the database 102.

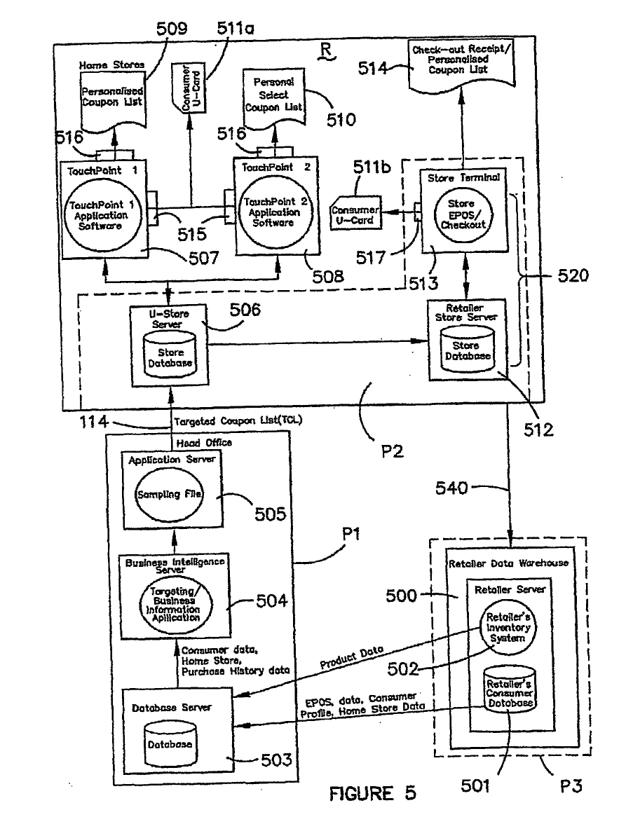

With reference to FIG. 5, a second embodiment is shown which relates to provision of coupons. A first processor P1 is located at a central location and second processors P2 are located at retail outlets R (only one retail outlet R and one processor P2 being shown in the drawing). The processor P1 is coupled to the processor P2 for the transmission of data by hardwiring, a network connection, internet connection or the like.

The processor P1 includes a database 503 which contains a database of consumers and particular characteristics of consumers. The characteristics include demographic information, products of preference based on shopping history of consumers, and also personal information such as whether the consumer has children, pets and other information upon which a decision can be based as to whether a consumer is likely to be interested in a particular type of product. This information can be obtained from the shopping habits of particular consumers, and also by a consumer filling in an application form to join the system and providing that information.

As is shown in FIG. 5, the database 503 is connected to a retailer's server 500. The retail server 500 may relate to a number of retail outlets R (only one shown in the drawings for ease of illustration) which are operated by the same organisation. Thus, a chain of retail outlets R may include, for example, ten different retail stores. A single server 500 is associated with all of those stores belonging to the same chain and may, for example, be located at an administrative office of the chain of stores. A different chain of stores will have its own server 500 for that particular chain of stores. The retail server 500 includes the retailer's inventory system 502 which contains information as to all of the products available in the retail outlet, and also a consumer database 501 which compiles information relating to consumers who shop in the store, the nature of products purchased, and also identifying data identifying the store. The database 501 collects information from the store EPOS checkout system 520 relating to products purchased by particular customers. The database 501 also contains data of the type described with reference to FIGS. 1 to 4 relating to attitude and geo-demographics, etc. The system 520 comprises an EPOS checkout 513 and store database server 513. Thus, details of products purchased by a particular consumer are provided from the EPOS checkout 513 to the database 512, and from the database 512 are provided to the retailer server 500 by way of a communication link 540 which may be a dedicated line, wide area network, or the like. Thus, a database of a particular customer identification and products purchased by that customer is obtained in each of the retail outlets R. The products purchased by a consumer are identified by the barcodes of the products as they are scanned at checkout and therefore a database is built up of products of particular interest to particular consumers. The data which is collected at each of the stores in a particular chain of stores is provided to the server 500 associated with that chain of stores. The information can be provided from the stores by way of a communication link to the server 500 or by otherwise loading information collected at the various store locations into the server 500. That data in the servers 500 is forwarded to the database 503 at the central location for compiling all of the data relating to consumers and characteristics from all of the stores operating the system.

The data contained in the retail server 500 is supplied to the database 503 via a communication link which again may be one of the types of links referred to above.

Thus, the database 503 is loaded with information which identifies particular consumers, products of interest to those consumers, attitudinal, demographic and other personal information relating to the consumers.

The processor P1 also includes a server 504 which includes software to process information relating to coupons which are intended to be provided, and also data contained in the database 503 to identify consumers who are likely to be interested in a particular product. The server 504 creates a target coupon list and sorts the list and categorises the list in accordance with the participating marketer's parameters for advertising by way of coupons. That is, the type of people the provider of the product wishes to attract and are therefore likely to be interested in purchasing or can be induced to buy because of another offer. Thus, the coupon may be used to directly advertise particular products by offering a discount in price or a giveaway or some other product. Alternatively, a purchase could be induced by the coupon to buy a product they have not tried before because of an associated offer, such as “if you purchase this product, you will receive two free movie tickets”. The list from the server 504 is provided to the application server 505, and the application server generates a sample file to re-categorise only the qualifying groups of consumers, and creates a targeted coupon list for each of the home retail stores at which the targeted consumers shop. Those lists are then sent to the various retail stores R by communication link 514. Thus, for each of the home stores, a list is forwarded which is then received in the store database 506 of the relevant retail outlet R.

Thus, the system collects purchase data from past purchases by consumers, and identifies the consumers who make the purchases, matching them with the particular home store at which they shop. By further matching the marketer's parameters (i.e. the supplier of the product which is to be advertised by way of the coupon) of what and whom the marketer's intended market is, a coupon file on the server 505 is created which typically includes information on the specific number of consumers at each participating home store. The relevance of receiving the coupon is based on the marketer's parameters, such as demographics, purchase behaviour, etc. The coupon file generated by the server 505 further identifies each of the targeted consumers and generates the targeted coupon list which is then sent electronically to each of the servers 506 at each relevant home store R.

The list which is received by the databases 506 in each of the retail outlets R is loaded into the computers 507 and 508 which are also connected to an input device such as a card reader for receiving a consumer's card 511a which identifies the consumer. The computers 507 and 508 also have a printer 516 which print coupons 509 and/or coupons 510 respectively for that particular consumer. Thus, when a consumer presents at the store, the consumer simply inserts his or her card 511a into one of the readers 515 and if any coupons are applicable to that particular consumer, the coupons 509, 510 are printed by one of the printers 516. The consumer is therefore provided with a coupon which the consumer may redeems.

In the case of the retail outlet being a virtual retail outlet which is accessed by the internet, the input of data identifying the user can be by way of pin number typed into a keyboard and the coupon 509, 510 can be provided by way of a web page. Obviously the products are not available at the person's home where the virtual shopping is conducted, and the person would need to visit a particular retail outlet or other location in order to collect the free samples.

The computer 507 and associated software, together with its card reader 515 and printer 516, may be provided close to an entrance of a store so that the consumer has access to the system as soon as the consumer enters the store. Thus, by the user presenting his or her card 511a, a personal coupon providing offers which are relevant to that particular consumer is printed on the printer 516.

The computer 508 and its associated software may be located elsewhere in the store such as near shopping isles or shelves where particular products are displayed to create interaction with the consumer at the particular place where products are selected. The computer 508 may include a television screen (not shown) which can display advertising material associated with the products in the proximity of the television and the computer 508. The consumer can insert his or her card 511a into the card reader 515 associated with the computer 508 and obtain a personal selective coupon which may relate specifically to products associated with the computer 508 and the advertisements on the television screen which may or may not be related to particular characteristics of the consumer stored in the database. This enables advertisers to attract interest of consumers with products they may not otherwise be familiar with or use and by virtue of their interaction with the computer 508 indicates some desire to products in that vicinity. Thus, the personal select coupon 510 may have different coupon offers to that which was obtained upon entry into the store, such as crossed-category coupon offers, e.g. bread and butter, meat with cooking sauces, etc.

The list which is created by the computer 508 may also include the complete targeted coupon, if not already provided by the computer 507.

The server 506 is connected with the retail store server 512 which in turn controls the EPOS checkout 513 associated with the store. Thus, the coupon offers which are provided to the consumer on the coupons 509 and 510 are electronically transmitted to the server 512 by the server 506 and provided to the EPOS checkout computer 513. Thus, when a consumer presents at the checkout, the person swipes his or her card 511b through a card reader 517 at the computer 513. The card reader 517 may be the usual card reader for reading a debit card or credit card or the like for making a financial transaction to pay for goods, or can be a separate card reader. Any purchases which are therefore made by the consumer, and which are included on the coupon are provided to the consumer in accordance with the offer on the coupon.

The processor P2 also processes the offers which have been redeemed by consumers so that appropriate advertisers who wish to make the offers on the coupon are billed in respect of those offers. Thus, calculation of billing requirements and parties to be billed are processed by the processor P2 by simply adding up of total values for billings to participating marketers or advertisers who provide the offers on the coupon. Thus, those advertisers are billed in relation to the redemptions which are made and provided by the stores. As these can be matched with the sales data electronically, reconciliation is simple and quick.

This does away with the need to actually collect coupons and physically supply the coupons to a clearing house for counting and for determining offers which have been redeemed by consumers, and therefore to enable billing back to participating marketers or advertisers.

In the preferred embodiment of the invention, the EPOS checkout terminal 513 determines the discounts or other offers automatically, because the terminal 513 is provided with details on the coupon provided to the particular customer, and the customer identifies himself or herself by card 511b which is inserted into reader 517. Thus, should the checkout terminal 513 process any product or the like which relates to an offer on the coupon, the consumer receives the offer, such as a discount in price or the like. The EPOS terminal determines all the discounts which are provided in relation to specific products, and they are forwarded to the retail server 512, which in turn forwards the data to a further processor P3. The further processor P3 may be the retailer warehouse server 500, or it can be a totally separate server or processor. Thus, all of the stores in the chain will forward data relating to discounts determined by the respective EPOS checkout terminals 513 to the server 500 for example, and the server 500 will compile the applicable discounts for each product, and for each participating advertiser making offers on the coupons. The participating advertisers can then be billed in respect of the discounts or offers which are provided by electronic invoice or otherwise, and the participating advertisers simply remit to the store chain. The chain of stores may then remit specific amounts to each of the retailers in its chain in accordance with the discounts or the like provided by each of those retail outlets.

Thus, the system of the preferred embodiment of the invention manages the entire coupon operation, including the issuance of coupons by the computers 507, 508 and 513, the redemption of the offers on the coupon, and calculation and billing back to participating marketers or advertisers. This therefore eliminates the need for costly physical coupons handling, and not only reduces the cost of printing each coupon separately, reducing the cashiers checkout processing time for better efficiency because no physical coupons need to be handled, but also eliminates the need for costly backend coupon clearing infrastructure. Thus, shorter queues at checkout result, and the need for handling and security is minimised. All transactions are electronic and more accurate than physical counting of printed coupons.

At the time of paying for products at the checkout computer 513, a further coupon 514 can be produced. Alternatively, this may be the only coupon which is produced, rather than producing coupons by computers 507 and 508 previously provided. In this case, the coupon 514 can be redeemed next time the person visits the store, and also provides an inducement to the consumer to return to the store because the consumer is provided with a new coupon at the time of leaving the store after making purchases.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A shopping system comprising:
(f) an input device for receiving an input to identify a shopper;
(g) a shopper database for storing data relating to shopping characteristics of shoppers;
(h) a processor for generating a shopping inducement for the shopper containing items of perceived interest to the shopper based on the data relating to the shopper stored in the shopper database;
(i) an output device for outputting the shopping inducement to the shopper; and
(j) wherein the shopping inducement comprises a shopping list which comprises a list of the items of perceived interest to the shopper, and an independently produced coupon containing additional benefits which is activated conditional upon also obtaining the shopping list.

2. The system of claim 1 wherein the shopper database is included in the processor.

3. The system of claim 1 wherein the processor comprises a first processor located at a central station and a second processor located at a retail outlet.

4. The system of claim 3 wherein the shopper database comprises a customer database included in the first processor and a store database included in the second processor.

5. The system of claim 4 wherein the first processor also includes a retailer EPOS server.

6. The system of claim 5 wherein the first processor includes a retailer central server.

7. The system of claim 3 wherein the first processor is programmed to generate and manage promotional offers applicable to all shoppers and targeted promotions which are targeted at specific shoppers, and is also programmed to select specific shoppers for the targeted promotion.

8. The system of claim 4 wherein the input device comprises a card reader for reading a card belonging to a shopper to thereby identify the shopper.

9. The system of claim 8 wherein the card reader is coupled to the store database for supplying data relating to the shopper to the store database.

10. The system of claim 1 wherein the output device is a printer coupled to the second processor for providing the shopping inducement in printed form.

11. The system of claim 5 wherein the store database is coupled to the retail EPOS server for providing data to the retail EPOS server identifying the shopper and also the items on the shopping inducement produced for the shopper.

12. The system of claim 11 wherein a secondary input device is coupled to the retail EPOS server for receiving an input to identify the shopper so that when items purchased by the shopper pass through check-out those items which are on the shopping list are supplied to the shopper in accordance with the promotional offer as provided on the shopping inducement.

13. The system of claim 6 wherein the retail central server is for receiving information relating to the shopping characteristics of shoppers, the retailer central server being coupled to the customer database for storing the shopping characteristics of the respective shoppers in the shopper database.

14. A shopping method comprising:
(e) receiving an input to identify a shopper;
(f) providing a shopper database which stores data relating to shopping characteristics of shoppers;
(g) generating a shopping inducement for the shopper containing items of perceived interest to the shopper based on the data relating to the shopper stored in the shopper database, the inducement comprises a shopping list of the items of perceived interest, and a coupon providing additional benefits conditionally activated upon obtaining the shopping list; and
(h) outputting the shopping inducement to the shopper.

15. The method of claim 14 wherein the method further comprises generating promotional offers applicable to all shoppers and targeted promotions which are targeted at specific shoppers, and selecting specific shoppers from the database for the targeted promotion.

16. The method of claim 14 wherein the method further includes supplying the data identifying the customer and the shopping inducement to a check-out station so that when the shopper passes through the check-out station items purchased by the shopper and which related to the shopping list are provided in accordance with the shopping list.

17. A system for providing a shopping inducement to a consumer, comprising:
an input device for receiving an input to identify a consumer;
a database for storing data relating to the characteristics of consumers, the data comprising past purchase history, attitudinal segmentation and geo-demographics;
a processor for determining consumers who are to receive the inducement based on the data contained in the database; and
an output device for providing the inducement to a consumer.

18. The system of claim 17 wherein the system further comprises a second processor for providing electronically details of the offers on the inducement provided to the consumer so that when the consumer presents at a checkout and pays for goods, any goods which are purchased and relevant to offers on the inducement are provided to the consumer in accordance with the offer on the inducement.

19. The system of claim 17 wherein the input device comprises a card reader for reading a card belonging to the consumer to identify the consumer.

20. The system of claim 19 wherein the card may be a smart card or a simple card having a magnetic strip.

21. The system of claim 17 wherein the database is retained in a central location and the processor comprises a first processor at the central location, the first processor receiving data from the database and processing the data for creating a targeted shopping inducement list.

22. The system of claim 18 wherein the second processor is located at a retail outlet for receiving the inducement list, the second processor being coupled to the output device for causing the output device to provide the inducement to the consumer.

23. The system of claim 17 wherein the output device comprises a printer which prints the coupon in response to a consumer inputting information into the input device to identify the consumer.

24. The system of claim 17 wherein the output device comprises an EPOS checkout location in a store for providing the inducement for redemption next time the consumer visits the store.

25. The system of claim 17 wherein a plurality of said input devices are provided throughout a retail outlet and a plurality of output devices are also provided so that, at different locations in a retail store, a consumer can obtain a coupon relevant to all products targeted for that particular consumer, or only products which are in the vicinity of the input device and output device to provide a greater degree of interaction between those particular products and the issuance of the inducement.

26. The system of claim 17 wherein the database also stores information relating to consumers which identifies a home store which the consumer frequents, and the first processor forwards the inducement list to the second processor located at the home store.

27. The system of claim 20 wherein the first processor includes the said database, a server for determining products which are to be included on the coupons, and the targeted consumers for receiving inducements, and an application server for generating the inducements list for transmission to the second processor.

28. The system of claim 18 wherein a said second processor is located at each stores operating the system, the second processor including a database for receiving the inducement list transmitted from the first processor, and for controlling the output device to provide the coupon to the consumer.

29. The system of claim 17 wherein the shopping inducement is a coupon or a shopping list.

30. A method of providing a shopping inducement to consumers, comprising:
identifying a consumer;
producing the inducement in response to an identified consumer containing offers relevant to the consumer based on data contained in a database, the data comprising past purchase history, attitudinal segmentation and geo-demographics; and
outputting the inducement to the consumer.

31. The method of claim 30 wherein the identification of a consumer is by a card reader for reading a card belonging to the consumer to identify the consumer.

32. The method of claim 30 wherein a database of consumer characteristics is retained in a central location and the method further comprises processing data from the database to create an inducement list to be provided for particular consumers based on the stored characteristics in the database, and products which are desired to be advertised by way of the provision of the inducement.

33. The method of claim 30 wherein the method also comprises receiving the inducement list at a retail outlet and processing the inducement list and information identifying consumers at the retail outlet to provide an indication of the consumers to receive the inducement.

34. The method of claim 33 wherein the indication is provided at an EPOS checkout location in a store for providing the indication of the consumer to receive the sample.

35. The method of claim 30 wherein the method also comprises identifying a home store at which the consumer purchase products and forwarding the inducement list to the home store.

36. The method of claim 32 wherein the processing at the central location is performed by a first processor which includes the said database, a server for determining products which are to be advertised on the inducement, and the targeted consumers for receiving those inducements, and an application server for generating the inducement list for transmission to the second processor.

37. The method of claim 33 wherein the processing at the retail outlet is performed by a second processor located at a retail store operating the system, the second processor including a database for receiving the coupon list transmitted from the first processor, and for controlling the output device to provide the coupon to the consumer.

38. The method of claim 30 wherein the inducement is a shopping list.

39. The method of claim 30 wherein the inducement is a coupon.

40. A system for providing coupons to consumers, comprising:
an input device for receiving an input to identify a consumer;
a database for storing data relating to the characteristics of consumers, the data comprising past purchase history, attitudinal segmentation and geo-demographics;
a processor for:
(a) producing a coupon and providing the coupon to a consumer based on the data contained in the database;
(b) providing electronically details of offers on the coupon to a redemption station so that when a consumer accepts at the redemption station offers on the coupon, the consumer receives the offers on the coupon; and
(c) providing electronically details of accepted offers on the coupon so participating parties making offers on the coupon can be billed in relation to those which are taken up by consumers; and
an output device for outputting the coupon to the shopper in response to the input received by the input device.

41. The system of claim 40 wherein the processor comprises a store server for producing the coupon and providing the coupon to a consumer, and an EPOS checkout terminal for receiving details of offers on the coupon relating to a particular consumer from the server, the EPOS checkout terminal forming the redemption station and processing offers on a coupon relating to a particular consumer in accordance with products purchased by the consumer at the checkout terminal, and a further processor for receiving electronically, details of offers provided to consumers for billing the participating parties making offers on the coupon.

42. The system of claim 40 wherein the system further comprises an input device for identifying a consumer.

43. The system of claim 40 wherein the system further includes an output device for providing the coupon to the consumer.

44. The system of claim 40 wherein the processor comprises a first processor and the first processor has a database for storing characteristics of consumers so that a coupon can be produced for particular consumer which contains offers relevant to the consumer based on information contained within the database relating to that consumer.

45. The system of claim 42 wherein the input device comprises a card reader for reading a card belonging to the consumer to identify the consumer.

46. The system of claim 44 wherein the first processor is located at a central location, the first processor receiving data from the database and processing the data for creating a targeted coupon list.

47. The system of claim 46 wherein the processor further comprises a second processor located at a retail outlet for receiving the coupon list, the second processor being coupled to the output device for causing the output device to provide the coupon to the consumer.

48. The system of claim 43 wherein the output device comprises a printer which prints the coupon in response to a consumer inputting information into the input device to identify the consumer.

49. The system of claim 43 wherein the output device comprises an EPOS checkout location in a store for providing the coupon for redemption next time the consumer visits the store.

50. The system of claim 40 wherein the database also stores information relating to consumers which identifies a home store which the consumer frequents and preferably, the first processor forwards the coupon list to the second processor located at that store.

51. A method of providing a coupon to a consumer, comprising:
detecting a consumer;
maintaining a database relating to consumer characteristics;
producing and providing the coupon to a consumer based on data contained in the database which stores characteristics of consumers so that the coupon can be produced for a particular consumer, which contains offers relevant to the consumer based on information contained within the database relating to that consumer;
providing electronically details of offers on the coupon to a redemption station so that when a consumer accepts at the redemption station offers on the coupon, the consumer receives the offers on the coupon; and
providing electronically details of accepted offers on the coupon so participating parties making offers on the coupon can be billed in relation to those which are taken up by consumers.

52. The method of claim 51 wherein the coupon is supplied to a consumer from a server and the server also supplies electronically, details of the coupon to an EPOS checkout terminal which comprises the redemption station, the EPOS checkout terminal processing sales relating to a consumer in accordance with details on a coupon provided to the consumer, and providing electronically, details of accepted offers to a further processor so the further processor can bill the participating parties in relation to the offers which are taken up by consumers.

53. The method of claim 51 wherein the method further comprises identifying a consumer so that the coupon relevant to the particular consumer can be produced.

54. The method of claim 51 wherein the method comprises receiving data from the database and processing the data for creating a targeted coupon list, and forwarding the targeted coupon list to a retail store for printing in response to the identification of a consumer at the retail store.

55. The method of claim 51 wherein the method also includes identifying a home store which the consumer frequents so that the targeted list can be forwarded to the home store relating to particular consumers.
